(19) United States
(12) Patent Application Publication
(10) Pub. No.: US 2024/0032500 A1
(43) Pub. Date: Feb. 1, 2024

(54) APPARATUS AND METHOD FOR DRAINING AND FORMING CURD

(71) Applicant: Tetra Laval Holdings & Finance S.A., Pully (CH)

(72) Inventor: Harrie SPIJKERMAN, Wapenveld (NL)

(73) Assignee: Tetra Laval Holdings & Finance S.A., Pully (CH)

(21) Appl. No.: 18/258,665

(22) PCT Filed: Dec. 20, 2021
(86) PCT No.: PCT/EP2021/086766

§ 371 Date: Jun. 21, 2023

(30) Foreign Application Priority Data
Dec. 29, 2020 (EP) 20217499.1

(51) Int. Cl. A01J 25/11; A01J 25/00; A01J 25/12

(52) U.S. Cl. CPC A01J 25/112; A01J 25/002; A01J 25/12

(57) ABSTRACT

An apparatus for draining and forming curd is presented. The apparatus comprises multiple, vertically arranged towers, a common curd distribution arrangement for distributing a curd and whey mixture into the multiple towers and a drainage section for draining whey from the curd and whey mixture. The drainage section forms a continuous space that extends horizontally over each of the multiple towers, each of the multiple towers having openings into the space formed by the drainage section for allowing whey to pass from the multiple towers and into the drainage section. A base unit beneath the multiple towers receives drained curd from the multiple towers and place the drained curd in moulds.

### TECHNICAL FIELD

The invention relates to cheese production in general, and more particularly to draining and forming curd.

### BACKGROUND ART

Today there are different technologies available for removing whey from a curd and whey mixture such that drained curd is obtained. One such technology is to use a vertical tower, also referred to as continuous drainage tower or column. In addition to remove whey from the curd and whey mixture, the drained curd fed out from the vertical tower can be formed into curd blocks that can be placed in moulds and transferred to a final processing station. The combination of draining and forming curd in one and the same equipment as well as the possibility to operate continuously has made vertical towers a widely used piece of equipment in cheese production, such as in semi-hard cheese production. One such example is the Tetra Pak® Casomatic system marketed and sold by Tetra Pak.

Even though the vertical tower is a well-known piece of equipment within the field of cheese production, there is room for improvement. For instance, to even further reduce losses related to inconsistent product quality, it is requested by cheese producers to have cheese towers that to an even higher degree deliver consistent curd quality. Further, shortened production time is often requested by the cheese producers.

This may for instance by achieved directly by having more efficient draining and forming, but also indirectly in that the curd quality is more consistent and thus resulting in fewer production stops. Another need in the industry is to offer cheese production equipment that takes less space.

Based on the above, there is a need for improved vertical towers that can deliver even higher curd quality consistency and also improved cost efficiency.

### SUMMARY

It is an object of the invention to at least partly overcome one or more of the above-identified limitations of the prior art. In particular, it is an object to provide an apparatus for draining and forming curd that can deliver improved curd consistency.

The object is generally achieved in that the apparatus comprises several towers linked to each other by one or several drainage sections such that the whey is allowed to be drained under mote similar circumstances. This may more efficiently balance out deviations in whey-to-curd ratios in the different towers, and thereby achieve a more consistent curd quality compared to when the different towers drain the curd and whey mixture in isolation, as is the case today.

According to a first aspect it is provided an apparatus for draining and forming curd, comprising multiple, vertically arranged towers, a common curd distribution arrangement for distributing a curd and whey mixture into the multiple towers, a drainage section for draining whey from the curd and whey mixture, the drainage section forming a continuous space that extends horizontally over each of the multiple towers, each of the multiple towers having openings into the space formed by the drainage section for allowing whey to pass from the multiple towers and into the drainage section, and a base unit arranged beneath the multiple towers to receive drained curd from the multiple towers and place the drained curd in moulds.

An advantage is that by having a common curd distribution arrangement as well as a drainage that extends over each of the towers, the whey can be more uniformly distributed and drained, making it possible to avoid deviations in curd-whey-ratio in the different towers. Having this possibility provides for that a more consistent curd quality can be obtained from the apparatus. An alternative or additional advantage is that more compact equipment can be realized due to the common curd distribution arrangement and by having one drainage section that extends over each of the towers.

The drainage section may be a first drainage section, and the curd drainage apparatus may comprise a second drainage section that is arranged vertically below the first drainage section for draining whey from the curd and whey mixture, the second drainage section forming a continuous space that extends horizontally over each of the multiple towers, each of the multiple towers having openings into the space formed by the second drainage section for allowing whey to pass from the multiple towers and into the second drainage section.

An advantage with having drainage sections at different heights is that the drainage of whey can be controlled with improved accuracy. Since a pressure formed by the curd and whey mixture at the second drainage section will be higher than a pressure formed by the curd and whey mixture and the first drainage section, placed above the second drainage section, different pressures can be applied for releasing the whey from the curd and whey mixture.

The curd drainage apparatus may further comprise a whey extraction pipe arrangement connected to each of the first and second drainage sections.

One advantage with having this pipe arrangement is that the apparatus can be made even more compact.

The apparatus may further comprise a control valve arranged to regulate a flow of whey leaving the drainage section, and a control unit arranged to regulate the control valve based on a difference between the pressure of the whey in drainage section and the pressure of the curd and whey mixture inside at least one of the towers at the location of the tower where the drainage section surrounds the tower.

By having the control valve, it is possible to adjust this such that a desired pressure inside the towers can be achieved. Since the pressure affects the whey drainage, this provides additional possibilities for cheese producers to meet desired properties of the drained curd, and thus the properties of cheese made from the curd.

The apparatus may further comprise a whey circulation unit connected to the drainage section and arranged to circulate whey over the drainage section, to increase the flow of whey and thereby release drained curd in the drainage section. An advantage of having the circulation unit is that small curd particles entering the drainage section can be more easily flushed away.

The curd and whey mixture distribution arrangement may be an agitating device arranged vertically above the multiple towers to distribute the curd and whey mixture into each of the multiple towers. An advantage with this is that a more uniform whey-to-curd ratio can be achieved in the different towers.

A volume of the drainage section, including the total volume of the parts of the towers passing through the drainage section, may be less than 40% larger than said total volume of said parts of the towers. One advantage with this is that a more compact apparatus may be realized. Another advantage is that the response time for controlling the whey drainage may be shorter since the volume of whey in the drainage section is relatively small. The volume of the drainage section is typically the same as the continuous space formed by the drainage section, i.e. it includes everything inside the volume, including the volume that is taken up by the towers. The total volume of the parts of the towers passing through the drainage section is the same volume as the volume the towers occupy within the drainage section.

The draining section may comprise a cleaning-in-place nozzle. An advantage with having the cleaning-in-place nozzle is that efficient cleaning of the apparatus can be achieved.

The base unit may comprise vertically movable dosing devices arranged underneath each of the multiple towers for receiving the drained curd, and a cutting unit for cutting the drained curd received by the dosing devices into blocks, wherein the dosing devices are configured to individually control the amount of curd that is received and cut from the respective tower. An advantage with this is that the base unit can compensate for deviations in curd quality, i.e. curd-to-whey ratio, by adapting the dosing devices and the cutting unit. Thus, this further reduces the risk of inconsistent curd quality. The dosing devices may configured to individually control the amount of curd that is received and cut from the respective tower by having a curd receiving platform that is lowered down until the desired volume or weight of curd has left the respective tower, and then the curd is cut of and placed in moulds.

A distance between two consecutively placed towers of the multiple towers may be less than 0.3 m. An advantage of having the towers placed close to one another is that efficient horizontal whey exchange can be achieved.

According to a second aspect it is provided a method for draining and forming curd, said method comprising distributing a curd and whey mixture into multiple towers by using a common distribution arrangement and via a common inlet, draining whey from the curd and whey mixture in a drainage section, the drainage section forming a continuous space that extends horizontally over each of the multiple towers, each of the multiple towers having openings into the space formed by the drainage section for allowing the whey to pass from the multiple towers and into the drainage section, receiving drained curd from the multiple towers by a base unit, arranged beneath the multiple towers, and placing the drained curd in moulds.

The same features and advantages as presented in view of the first aspect may be implemented for and applies to this second aspect.

Still other objectives, features, aspects and advantages of the invention will appear from the following detailed description as well as from the drawings.

### BRIEF DESCRIPTION OF THE DRAWINGS

Embodiments of the invention will now be described, by way of example, with reference to the accompanying schematic drawings, in which

FIG. 1a illustrates a front view of an apparatus for draining and forming curd.

FIG. 1b illustrates a side view of the apparatus illustrated in FIG. 1a.

FIG. 2 is a flow chart illustrating a method for draining and forming curd.

### DETAILED DESCRIPTION

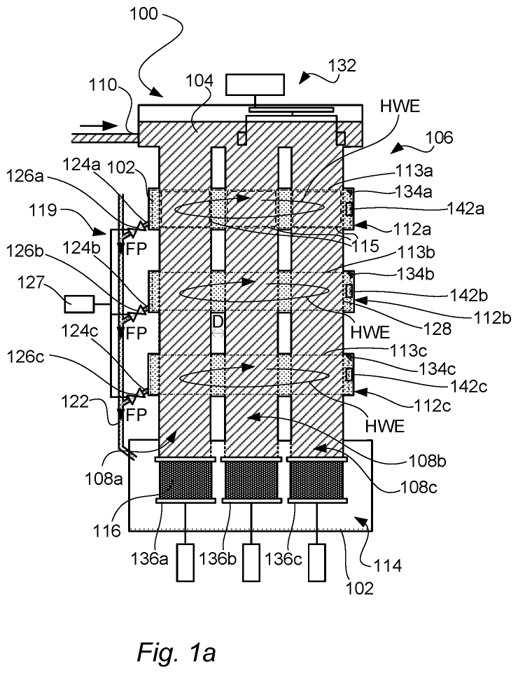

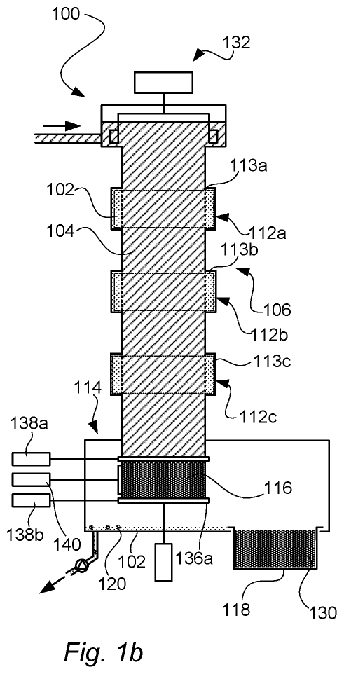

FIGS. 1a and 1b generally illustrate an apparatus 100 for draining and forming curd. FIG. 1a illustrates a front view of the apparatus 100 and FIG. 1b illustrates a side view of the apparatus 100.

A purpose of the apparatus 100 is to remove whey 102 from a curd and whey mixture 104. To achieve this the apparatus 100 can comprise a number of towers 108a-c. In the particular example illustrated in FIGS. 1a and 1b, three towers 108a-c are used, but fewer or more towers may also be used.

The curd and whey mixture 104 can be fed into a common inlet 110 of the apparatus 100. As illustrated, this common inlet 110 may be placed in a top section of the apparatus 100, on top of the towers 108a-c. From the common inlet 110, the curd and whey mixture can be fed down into the towers 108a-c.

Each of the towers 108a-c can be provided with one or several drainage sections 112a-c arranged at different heights of the towers 108a-c. In the example illustrated, three drainage sections 112a-c are provided. Each of the drainage sections 112a-c form a continuous space 113a-c that can extend horizontally over each of the towers 108a-c. Having the apparatus 100 arranged in this way allows for that the whey to be drained from the different towers 108a-c at different heights of the towers 108a-c.

A volume of the drainage section 112a, including the total volume of the parts 115 of the towers 108a, 108b, 108c passing through the drainage section (112a), may be less than 40% larger than said total volume of said parts 115 of the towers 108a, 108b, 108c.

Below the towers 108a-c, a base unit 114 can be arranged. Since whey 102 has been removed from the curd and whey mixture 104 during the transfer down the towers 108a-c, the curd and whey mixture 104 has been transformed into drained curd 116.

The drained curd 116 can, due to a lower whey content, be placed in moulds 118 and thereafter be processed further, e.g. final pressing, brining and ripening.

To remove the whey 102 from the drainage sections 112a-c, a whey extraction pipe arrangement 119 can be provided. As illustrated, the whey extraction pipe arrangement 119 can be connected to lower sections of the drainage sections 112a-c such that released whey 102 can be extracted from the drainage sections 112a-c to the base unit 114. The whey 102 is released from the curd and whey mixture 104 due to a pressure formed in the towers 108a-c by the gravity. The pressure in the drainage sections 112a-c may also be controlled for obtaining the desired whey drainage. Then, increasing the pressure in the drainage sections 112a-c reduces the drainage, while decreasing the pressure in the drainage sections 112a-c increases the whey drainage.

The whey 102 extracted via the whey extraction pipe arrangement 119 can be used for flushing out curd remains, also referred to as curd particles 120, in the base unit 114. By using the whey 102 in this way, there is no need to add water or similar to provide for that there is no build-up of curd particles 120 in the base unit 114. This in turn provides for that the whey 102 leaving the base unit 114 comprises the whey 102 released from the curd and whey mixture 104 via the drainage sections 112a-c and the curd particles 120 flushed out from the base unit 114. Avoiding adding water provides for a more cost efficient piece of equipment, but also in that less liquid needs to be removed from the whey 102 when, for example, this is later transformed into whey powder.

The common whey extraction pipe arrangement 119 can comprise a main pipe 122 and connection pipes 124a-c. The connection pipes 124a-c can be connected to the drainage sections 112a-c such that flow paths FP are provided from the drainage sections 112a-c to the main pipe 122. The connection pipes 124a-c can be provided with control valves 126a-c. Having the control valves 126a-c on the connection pipes 124a-c provides for that horizontal whey exchange HWE in the different drainage sections 112a-c can be controlled. For instance, in case the control valve 126a of the first drainage section 112a is closed, the whey 102 will be directed downwards to the second and third drainage section 112b, 112c, thereby affecting the horizontal whey exchange HWE in the second and third drainage section 112b, 112c. The amount of whey 102, or more particularly a ratio between whey and curd, has namely an effect on the horizontal whey exchange HWE. To control the control valves 126a-c, a control unit 127 can be used. This control unit 127 can be used for controlling the control valves 126a-c individually or in combination as explained above.

The towers 108a-c are provided with openings 128 such that the whey 102 can pass from the towers 108a-c into the continuous spaces 113a-c while the curd 116 is kept inside the towers 108a-c and fed downwards to the base unit 114. The control unit 127 can control the draining of whey by regulating the valves 126a-c. By opening a valve to let out more whey, draining is increased for the associated drainage section. This is because less whey in the draining section causes less “back pressure” on the curd and whey mixture in the towers.

As illustrated, in the base unit 114, which may be shared by several towers 108a-c, the drained curd 116 can be formed into curd blocks 130 and placed in the moulds 118. After being placed in the moulds 118, the curd blocks 130 can be transferred to a final pressing station (not illustrated).

To provide for that the curd and whey mixture 104 is distributed evenly in the different towers 108a-c, that is, that a similar ratio of curd and whey is fed into the different towers 108a-c, a common curd distribution arrangement 132 can be used. As illustrated, the common curd distribution arrangement 132 can be an agitating device, herein illustrated as a two axle provided agitating device, arranged to mix the curd and whey mixture 104 such that a similar ratio of curd and whey is provided in the different towers 108a-c.

The drainage sections 112a-c can be provided with cleaning-in-place (CIP) nozzles 134a-c such that efficient cleaning can be provided.

The base unit 114 can be provided with vertically movable dosing devices 136a, 136b, 136 arranged underneath each of the multiple towers 108a, 108b, 108c for receiving the drained curd 116. The dosing devices 136a-c can be individually controlled, which is advantageous since the moisture content may vary in the different towers 108a-c. The controlling of the different dosing devices 136a-c may be made based on height and/or on weight. Once a height setpoint and/or a weight setpoint is reached, i.e. once the desired height and/or weight is achieved, a cutting unit 138a can be used for cutting of the drained curd 1126 such that the curd block 130 is formed. As illustrated, the cutting unit 138a can comprise an upper cutting element 138a arranged for dividing the curd block 130 from the drained curd 116 fed out from the towers 108a-c. A lower, vertically and horizontally movable element 138b is arranged below the cutting unit 138a for receiving the curd block 130. The same element 138b may be used for accomplishing the above described dosing. Once cut-off from the drained curd 116 fed out from the towers 108a-c and resting on the lower element 138b, a pusher unit 140 may be used for pushing the curd block 130 into the mould 118. The movable lower element 138b may be moved towards the mould 118 for assisting in placing the curd block 130 into the mould 118. For illustrative purposes only one cutting unit 138a, lower element 138b and pusher unit 140 are illustrated, but to provide for that the curd blocks 130 can be formed individually for the different towers 108a-c, there can be one cutting unit, lower element and pusher unit 140 for each tower 108a-c.

The horizontal whey exchange HWE may arise due to variations of curd and whey content in the different towers 108a-c, e.g. a tower holding curd and whey mixture 104 with a higher content of whey 102 compared to the curd and whey mixture 104 held a neighboring tower. The difference in variations of curd and whey content in the different towers 108a-c may be decreased due the common drainage sections, as these provide the same level of whey in each drainage section. This result in a similar back pressure for each tower which allows the curd and whey in the different towers to balance out and approach each other, while still keeping the design of the apparatus 100 simple and efficient.

Circulation units 142a-c may be provided in the drainage sections 112a-c. The circulation units 142a-c may be a pump arrangement arranged to create an increased circulation inside the drainage sections 112a-c, by feeding whey out from the respective drainage section and back into the same drainage section. By having this active circulation any curd particles passing through the openings 128 in the towers, into the drainage section 112a-c, may be efficiently flushed away.

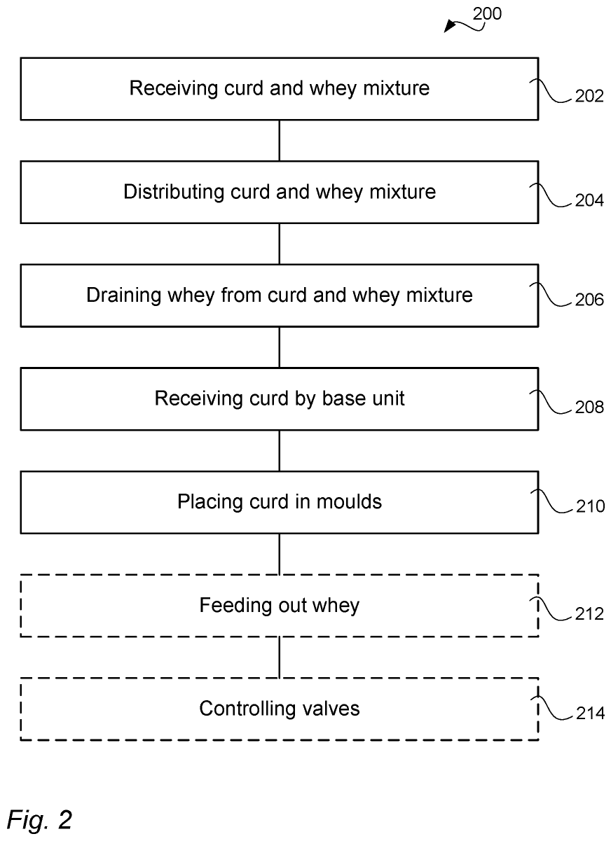

FIG. 2 is flow chart illustrating a method 200 for draining and forming curd. In a first step 202, the curd and whey mixture 104 can be received in the apparatus 100 via the common inlet 110. As described above, the apparatus 100 can comprise multiple towers 108a-c. In a second step 204, the curd and whey mixture 104 can be distributed into the multiple towers 108a-c by using the common distribution arrangement 132. In a third step 206, the whey 102 can be drained from the curd and whey mixture 104, into the drainage section 112a-c. As described above, the drainage section 112a-c can form the continuous space 113a-c that extends horizontally over each of the multiple towers 108a-c. Each of the multiple towers 108a-c can have openings 128 into the space 113a-c formed by the drainage section 112a-c for allowing the whey 102 to pass from the multiple towers 108a-c into the drainage section 112a-c. In a fourth step 208, the drained curd 116 from the multiple towers 108a-c can be received by the base unit 114, arranged beneath the multiple towers 108a-c. In a fifth step 210, the drained curd 116 can be placed in the moulds 118.

Optionally, in a sixth step 212 the whey 102 released from the curd and whey mixture 104 can fed out from the drainage section 112a-c via the common whey extraction pipe arrangement 119 to the base unit 114. As described above, the common whey extraction pipe arrangement 119 may comprise the main pipe 122 and the connection pipes 124a-c provided with the control valves 126a-c. The connection pipes 124a-c may provide the fluid path FP for the whey 102 from the drainage section 112a-c to the main pipe 122. In a seventh step 214, the control valves 126a-c can be controlled individually such that the draining of whey from the multiple towers 108a-c can be adjusted.

From the description above follows that, although various embodiments of the invention have been described and shown, the invention is not restricted thereto, but may also be embodied in other ways within the scope of the subject-matter defined in the following claims.

1. An apparatus for draining and forming curd, comprising
multiple, vertically arranged towers,
a common curd distribution arrangement for distributing a curd and whey mixture into the multiple towers,
a drainage section for draining whey from the curd and whey mixture, the drainage section forming a continuous space that extends horizontally over each of the multiple towers, each of the multiple towers having openings into the space formed by the drainage section for allowing whey to pass from the multiple towers and into the drainage section, and
a base unit arranged beneath the multiple towers to receive drained curd from the multiple towers and place the drained curd in moulds.

2. The apparatus according to claim 1, wherein the drainage section is a first drainage section, the curd drainage apparatus comprising a second drainage section that is arranged vertically below the first drainage section for draining whey from the curd and whey mixture, the second drainage section forming a continuous space that extends horizontally over each of the multiple towers, each of the multiple towers having openings into the space formed by the second drainage section for allowing whey to pass from the multiple towers and into the second drainage section.

3. The curd drainage apparatus according to claim 2, comprising
a whey extraction pipe arrangement connected to each of the first and second drainage sections.

4. The apparatus according to claim 1, comprising a control valve arranged to regulate a flow of whey leaving the drainage section, and a control unit arranged to regulate the control valve based on a difference between the pressure of the whey in drainage section and the pressure of the curd and whey mixture inside at least one of the towers at the location of the tower where the drainage section surrounds the tower.

5. The apparatus according to claim 1, comprising a whey circulation unit connected to the drainage section and arranged to circulate whey over the drainage section, to increase the flow of whey and thereby release drained curd in the drainage section.

6. The apparatus according to claim 1, wherein the curd and whey mixture distribution arrangement is an agitating device arranged vertically above the multiple towers to distribute the curd and whey mixture into each of the multiple towers.

7. The apparatus according to claim 1, wherein a volume of the drainage section, including the total volume of the parts of the towers passing through the drainage section, is less than 40% larger than said total volume of said parts of the towers.

8. The apparatus according to claim 1, wherein the draining section comprises a cleaning-in-place nozzle.

9. The apparatus according to claim 1, wherein the base unit comprises
vertically movable dosing devices arranged underneath each of the multiple towers for receiving the drained curd, and
a cutting unit for cutting the drained curd received by the dosing devices into blocks, wherein
the dosing devices are configured to individually control the amount of curd that is received and cut from the respective tower.

10. The apparatus according to claim 1, wherein a distance between two consecutively placed towers of the multiple towers is less than 0.3 m.

11. A method for draining and forming curd, said method comprising
distributing curd and whey mixture into multiple towers by using a common distribution arrangement and via a common inlet,
draining whey from the curd and whey mixture in a drainage section, the drainage section forming a continuous space that extends horizontally over each of the multiple towers, each of the multiple towers having openings into the space formed by the drainage section for allowing the whey to pass from the multiple towers and into the drainage section,
receiving drained curd from the multiple towers by a base unit, arranged beneath the multiple towers, and
placing the drained curd in moulds.
